(19) United States
(12) Patent Application Publication
(10) Pub. No.: US 2005/0103340 A1
(43) Pub. Date: May 19, 2005

(54) Methods, systems & devices for endobronchial ventilation and drug delivery

(76) Inventor: Anthony David Wondka, Westlake Village, CA (US)

Correspondence Address: ANTHONY D. WONDKA, 944 EVENSTAR AVE., WESTLAKE VILLAGE, CA, 91361, US

(21) Appl. No.: 10/923,128

(22) Filed: Aug. 20, 2004

Related U.S. Application Data
(60) Provisional application No. 60/496,581, filed on Aug. 20, 2003.

(51) Int. Cl. A62B 7/00

(52) U.S. Cl. 128/204.18

(57) ABSTRACT

Methods, systems and devices are described for Endobronchial Ventilation using an endobronchially implanted ventilator for the purpose of treating COPD, emphysema and other lung diseases. Endobronchial drug delivery is also described using an endobronchially implanted drug pump, for therapeutic treatment of the lung or of other organs and tissues.

### BACKGROUND OF THE INVENTION

Emphysema is the worst form of Chronic Obstructive Pulmonary Disease (COPD) which is a worldwide problem of high prevalence, effecting tens of millions of people and is one of the top five leading causes of death. Emphysema is characterized by airway obstruction, tissue elasticity loss and trapping of stagnant air in the lung. There are two basic origins of emphysema; a lesser common origin stemming from a genetic deficiency of alpha₁-antitripsin and a more common origin caused by toxins from smoking or other environment sources. Both forms are pathologically described as a breakdown in the elasticity in the functional units, or lobules, of the lung. More specifically, elastin fibers in the septums that separate alveoli are destroyed, changing clusters of individual alveoli into large air pockets, thereby significantly reducing the surface area for gas transfer. In some cases air leaks out of the minute airways because of their fragile walls through the parenchymal tissue to the periphery of the lung causing the membranous lining to separate and forming large air vesicles called bullae. Also due to elasticity loss, small conducting airways leading to the alveoli become flaccid and have a tendency to collapse during exhalation, trapping large volumes of air in the now enlarged air pockets, thus reducing bulk air flow exchange and causing CO₂ retention in the trapped air. Mechanically, because of the large amount of trapped air at the end of exhalation (known as elevated residual volume), the intercostal and diaphragmatic inspiratory muscles are forced into a pre-loaded condition, reducing their leverage at the onset of an inspiratory effort thus increasing work-of-breathing and dyspnea. Also, areas with more advanced emphysema and more trapped air tend to comprise the majority of the chest cavity volume and tend to fill preferentially during inspiration due to their low elasticity, thus causing the healthier portions to be disproportionately compressed rather than inflating normally during inspiration. In emphysema therefore more effort is expended to inspire less air and the air that is inspired contributes less to gas exchange. Approximately 15% of smokers develop emphysema and a much greater percentage develop less severe COPD.

Current prescribed therapies for emphysema and other forms of COPD include pharmacological agents (beta-agnonist aerosolized bronchodilators and anti-inflammatories), supplemental nasal oxygen therapy, ventilation therapies, respiratory muscle rehabilitation, pulmonary hygiene (lavage, percussion therapy), and lung transplantation. These therapies all have certain disadvantages and limitations with regard to effectiveness, risk or availability. Usually, after progressive decline in lung function despite attempts at therapy, patients become physically incapacitated or sometimes require mechanical ventilation to survive in which case weaning from ventilator dependency is difficult.

Because there is no adequate treatment for such a prevalent disease, there have been significant efforts to discover new treatments.

One proposed new therapy is treatment with substances that protect the elastic fibers of the lung tissue. This approach may slow down the progression of the disease by blocking continued elastin destruction, but a successful treatment is many years away, if ever. Some day, it may be possible to treat or even prevent emphysema using biotechnology approaches such as monoclonal antibodies, stem cell therapy, viral therapy, cloning, or xenographs. However, these approaches are in very early stages of research, and will take many years before their viability is even known.

In order to satisfy the growing and immediate need for a better therapy a surgical approach called lung volume reduction surgery (LVRS) has been used and extensively studied and proposed by many as a standard of therapy. This surgery involves opening the patient's chest and surgically resecting some of the diseased hyperinflated lung tissue, usually resecting the most accessible regions (the apical sections). Once this tissue is removed, the lung's breathing mechanics and gas exchange may improve. The surgery is more suited for heterogeneous emphysema (for example if the disease is significantly worse in the upper lobes) as opposed to homogeneous emphysema (when the disease is spread diffusely throughout the lung). Approximately 8000 people have undergone LVRS, however the results are not always favorable. There is a high complication rate of about 20% (air leaks, infection), patients don't always feel a benefit (perhaps partly due to the indiscriminate nature of the resection), there is a high degree of surgical trauma, and it is difficult to predict which patients will feel a benefit. Therefore LVRS offers only a small contribution to the widespread scale of this problem and inarguably some other approach is needed.

The attention on LVRS has however precipitated new ideas and work on how to obtain the mechanical benefits of LVRS but using lesser invasive approaches. These approaches are presently in experimental phases and are reviewed below with other prior art.

Ventilatory modes for treating COPD are well established in the prior art, some of which are described below:

One existing ventilatory method is ventilation of a lung with gases of low molecular weights and low viscosity, such as helium-oxygen mixtures or nitric oxide, in order to decrease gas flow resistance and lower surface tension in distal airways and alveolar surfaces, thus increasing oxygen transfer across the alveolar surface into the blood. Another existing ventilatory method for treating COPD is Tracheal Oxygen Gas Insufflation which reduces CO₂ content in the upper airways during either mechanical or natural ventilation thus allowing higher O₂ concentrations to reach the distal airways. Other methods include liquid perfluorocarbon ventilation (which can displace mucous in distal airways thus improving gas flow); continuous positive airway pressure applied via nasal mask (which lowers the work of inspiration and decreases CO₂ content in the residual volume by continually forcing fresh air into the lung); nasal supplemental oxygen therapy (which increases oxygen content in the lung); high frequency jet ventilation (which lowers the mean airway pressure during mechanical ventilation allowing more oxygen to be delivered without using higher pressure). All these methods typically ventilate COPD patients more effectively, however the effect is only transient and they do not reduce the debilitating elevated residual volume that exists with emphysema. These methods are in-effective partly because they employ ventilation on the entire lung as a whole. The present invention disclosed herein addresses some of these shortcomings as will become apparent in the later descriptions.

In addition to ventilatory modes for treating COPD, new minimally invasive lung volume reduction methods are also well described in the prior art. Prior art includes U.S. Pat. Nos. 5,972,026; 6,083,255; 6,174,323; 6,488,673; 6,514,290; 6,287,290; 6,527,761; 6,258,100; 6,293,951; 6,328,689; 6,402,754; 0020042564; 0020042565; 0020111620; 0010051799; 0020165618; and foreign patents EP 1078601; WO98/44854; WO99/01076; WO99/32040; WO99/34741; WO99/64109; WO0051510; WO00/62699; WO01/03642; WO01/10314; WO01/13839; WO01/13908 WO01/66190.

U.S. Pat. No. 6,328,689 describes a method wherein lung tissue is sucked and compressed into a compliant sleeve placed into the pleural cavity through an opening in the chest. While this method may be less traumatic than LVRS it presents new problems. First, it will be difficult to isolate a bronchopulmonary segment for suction into the sleeve. In a diseased lung the normally occurring fissures that separate lung segments are barely present. Therefore, in order to suck tissue into the sleeve as proposed in the referenced invention, the shear forces on the tissue will cause tearing, air leaks and hemorrhage. Secondly the compliant sleeve will not be able to conform well enough to the contours of the chest wall therefore abrading the pleural lining as the lung moves during the breathing, thus leading to other complications such as adhesions and pleural infections.

U.S. Patent applications 2002/0147462 and 2001/0051799 explain methods wherein adherent substances are introduced to seal the bronchial lumen leading to a diseased area. It is proposed in these inventions that the trapped gas will dissipate with time. The main flaw with this method is that the gas will not effectively dissipate, even given weeks or months. Rather, a substantial amount of trapped gas will remain in the blocked area and the area will be at heightened infection risk due to mucous build up and migration of aerobic bacteria. The reason the gas will not dissipate is three-fold: (1) low or no diffusion into blood due to compromised perfusion, exacerbated by the Euler reflex, (2) low diffusion into the tissue due to poor diffusivity of CO₂ and (3) infusion of additional CO₂ into the blocked area through intersegmental collateral flow channels from neighboring areas. Another disadvantage with this invention is adhesive delivery difficulty; Controlling adhesive flow along with gravitational effects make delivery awkward and inaccurate. Further, if the adhesive is too hard it will be a tissue irritant and if the adhesive is too soft it will likely lack durability and adhesion strength. Some inventors are trying to overcome these challenges by incorporating biological response modifiers to promote tissue in-growth into the plug, however due to biological variability these systems will be unpredictable and will not reliably achieve the relatively high adhesion strength required. A further disadvantage with an adhesive bronchial plug, assuming adequate adhesion, is removal difficulty, which is extremely important in the event of post obstructive pneumonia unresponsive to antibiotic therapy, which is likely to occur as previously described.

U.S. Pat. No. 5,972,026 describes a method wherein the tissue in a diseased lung area is shrunk by heating the collagen in the tissue. The heated collagen fibers shrink in response to the heat and then reconstitute in their shrunk state. However, a flaw with this method is that the collagen will have a tendency to gradually return towards its initial state rendering the technique ineffective.

U.S. Pat. Nos. 6,174,323 and 6,514,290 describe methods wherein the lung tissue is endobronchially retracted by placing anchors connected by a cord at distal and proximal locations then shortening the distance between the anchors, thus compressing the tissue and reducing the volume of the targeted area. While technically sound, there are three fundamental physiological problems with this method. First, the rapid mechanical retraction and collapse of the lung tissue will cause excessive shear forces, especially in cases with pleural adhesions, likely leading to tearing, leaks and possibly hemorrhage. Secondly, distal air sacs remain engorged with CO₂ hence occupy valuable space without contributing to gas exchange. Third, the method does not remove trapped air in bullae. Also, the anchors described in the invention are not easily removable and they will likely tear the diseased and fragile tissue.

U.S. Patent Applications 2002/0042564, 2002/0042565 and 2002/0111620 describe methods where artificial channels are drilled in or toward the periphery of the lung parenchyma so that trapped air can then communicate more easily with the conducting airways and ultimately the upper airways, and/or to make intersegmental collateral channels less resistive to flow, so that CO₂-rich air can be expelled better during respiration. Its inventors propose that this method may be effective in treating homogeneously diffuse emphysema by preventing air trapping throughout the lung, however the method does not appear to be feasible because of the vast number of artificial channels that would need to be created to achieve effective communication with the vast number lobules trapping gas.

U.S. Pat. No. 6,293,951 and foreign patent WO01/66190 describe placing a one-way valve in the feeding bronchus of the diseased lung area. The proposed valves allow flow in the exhaled direction but not in the inhaled direction, with the intent that over many breath cycles, the trapped gas in the targeted area will escape through the valve thus deflating the lung compartment. This mechanism can be only partially effective due to fundamental lung mechanics, anatomy and physiology. First, because of the low tissue elasticity of the targeted diseased area, a pressure equilibrium is reached soon after the bronchus is valved, leaving a relatively high volume of gas in the area. Hence during exhalation there is an inadequate pressure gradient to force gas proximally through the valve. Secondly, small distal airways still collapse during exhalation, thus still trapping air. Also, the area will be replenished with gas from neighboring areas through intersegmental channels, trapped residual CO₂-rich gas will not completely absorb or dissipate over time and post-obstructive pneumonia problems will occur as previously described. Finally, a significant complication with a bronchial one-way valve is inevitable mucous build up on the proximal surface of the valve rendering the valve mechanism faulty.

U.S. Pat. Nos. 6,287,290 and 6,527,761 describe methods for deflating a diseased lung area by first isolating the area from the rest of the lung, aspirating trapped air by applying vacuum to the bronchi in the area, and plugging the bronchus either before or after deflation. These methods also describe the adjunctive installation of Low Molecular Weight gas into the targeted area to facilitate aspiration and absorption of un-aspirated volume. It is appreciated in these inventions that aspiration of trapped air may require sophisticated vacuum parameters (amplitude, phase, waveform, periodicity, etc.). While apparently physiologically and clinically sound, these methods still have some inherent and technical disadvantages.

U.S. Patent Application 20030127090 (Gifford) describes the use of an implanted active pump for the removal of trapped air to reduce the hyperinflation of an emphysematous area. This invention is significantly limited in its use to removal of air; most clinical situations will require far greater functionality than air removal, such as but not limited to air delivery, drug delivery, volume and pressure regulation of the targeted area, and access of the area distal to the implant.

To summarize, existing methods and methods under study for minimally invasive lung volume reduction have the following shortcomings: (1) they are either ineffective in collapsing the hyperinflated diseased lung areas; (2) they allow re-inflation of the area due to inflow through collateral collateral channels or reverse diffusion; (3) they do not remove air in bullae; (4) they collapse tissue too rapidly causing shear-related injury; (5) they cause post-obstructive pneumonia; (6) they do not allow direct therapeutic treatment of the targeted area after reduction; (7) they do not regulate a desired amount of volume in the treated area and allow for the regulated flow of desired quantity of inspired and exhaled air.

The present invention disclosed herein takes into consideration the anatomical, physiological and physical problems and challenges not solved by the aforementioned prior art methods. In summary, this invention uses an implanted ventilator mechanism to accomplish an effective, gradual and safe collapse of an emphysematous lung area to a volume that is safe and clinically appropriate and actively sustains that volume indefinitely. This invention solves the problems of collapsible airways and air trapping, tissue shear that occurs with rapid collapse, post-obstructive pneumonia that occurs from the mucous build up distal to an obstruction, mucous that malfunctions implanted passive valves, collateral channel reinflation, and bulla air trapping. Further the invention allows for the treated area to remain viable by maintaining a small amount of air volume in it; this will allow for continued blood perfusion by not activating the Euhler reflex and hence the potential clinical problems associated with fibrotic or necrotic tissue is not of a concern. Further, this invention allows delivery of therapeutic substances distally in situations where treatment is required. These methods and devices thereof are described below in more detail.

With regard to medication delivery, the current state-of-the-art for medication delivery includes intravenous application, subdermal, intramuscular or subcutaneous injections, transdermal patches, oral inhalation, or implanted pumps implanted subdermally. For medication delivery via the lung (to the lung itself or to other parts of the body) is performed through inhalation. These methods can be very limited in specificity, programmability, convenience, effectiveness, etc., and a better method and scheme of delivery may be useful in reaching the therapeutic potential of many drugs.

There is no prior art being used in medicine, or described in the medical or scientific literature, related to the implantation of micro-pumps for drug delivery in the lung's airways in general, nor specifically for the purpose of creating lung area collapse or for medication delivery. Various pump implants in other parts of the body are described, such as intrathecal, coclear, penile, heart and subdermal, as well as pumps for insulin delivery and for pain management. Thus described in this invention is the novel use of an endobronchially implanted drug pump that is effective in treating lung disease and also diseases throughout the body by using the gas transfer surface as a delivery gate.

### SUMMARY OF THE INVENTION

In a first main embodiment of the present invention a method is disclosed for treating a lung area by using an implanted endobronchial ventilator device (EVD) mechanism which is implanted in the airway that leads to the targeted area, typically for the purpose of treating emphysema, but also for treating a variety of other conditions. When used to treat emphysema, the targeted area is an emphysematous area of a lung (a lobe, segment or subsegment) which is not contributing to ventilation and which has degraded elasticity and is typically hyperinflated with stagnant air. The EVD seals the airway in which it is implanted except for material passing through the EVD itself. The EVD then ventilates the isolated targeted area in a controlled manner, typically more air is removed during the expiratory phase than the amount of air delivered during the inspiratory phase of the EVD. The ventilation parameters are regulated carefully to ultimately result in a reduced volume of the targeted lung area such that it is not hyperinflated. Typically for a lung lobe, the lobe is reduced from 1.5 liters to about 0.5 liters of air; the lobe is then ventilated to maintain the therapeutic volume of 0.5 liters of air for the duration of the therapy. The EVD removes the fluid (gas and liquid) from the targeted area by transporting the fluid proximally across the valve The pumping force is designed to be enough force to draw the necessary fluid from the distal spaces into the EVD and through the EVD, however without creating too much vacuum force that would trap air behind collapsed airway. The ventilation action is designed to cause a gradual, not sudden, collapse of the lung area and after collapse is complete the ventilation action may continue at a reduced level to sustain the collapse (in the event that the targeted area refills with air from collateral channels or diffusion or from mucous production). The EVD ventilation action can be permanent or temporary (acute, sub-chronic or chronic) and the implantation of the EVD can also be permanent or temporary. The EVD is typically endoscopically placed, and if removed, endoscopically removed. The EVD can be of a variety of ventilation mechanisms, but is typically a unidirectional positive displacement pump, with a long life lithium vanadium pentoxide battery. The EVD can also deliver medication distally (in which case a bidirectional pump, medication reservoir or instrument pass-through port is used) in order to treat a variety of disorders. For example, while collapsing and sustaining the collapse of a previously emphysematous segment, the EVD can deliver therapeutics (e.g., a gene therapy agent) distally into the collapsed segment to attempt to restore the elasticity of and rehabilitate the segment such that the segment can later be recruited to participate in ventilation. In a similar manner, the EMP can also be used for treating bronchitis, asthma, TB, pneumonia, cancer, SARS, ARDS, cystic fibrosis, pulmonary fibrosis, pleural disease and other respiratory diseases.

In a second main embodiment of the present invention, disclosed is a method for delivering therapeutics using an endobronchial drug pump (EDP) implant which is used for direct as-needed medication delivery anywhere in the lung to treat any known lung disease, or for release into the lung for systemic diffusion elsewhere in the body. For example, chemotherapeutics, antibiotics, antifungals, CHF therapies, neurovascular drugs, cardiovascular drugs, peripheral vascular drugs, blood pressure medication, analgesics, narcotics, allergy drugs or sleeping disorder drugs can all be delivered in this manner, to name a few. In these cases the EDP includes the requisite medication reservoir and may be implanted without occluding the airway in which it is placed.

It can be appreciated that there are many applications of the present invention where the EVD and EDP embodiments are combined to create the desired clinical therapy.

### BRIEF DESCRIPTION OF THE DRAWINGS

FIG. 1A describes the anatomy of a lung.

FIG. 1B describes a cut away view of part of the lung.

FIG. 1C describes a cluster of normal alveoli.

FIG. 1D describes a cluster of emphysematous alveoli.

FIG. 2 describes Endobronchial Ventilation on a ventilatory dependent patient.

FIG. 3A describes Endobronchial Ventilation or Endobronchial Drug Delivery on an ambulatory spontaneously breathing patient.

FIG. 3B describes a receiving and control station for monitoring and controlling the Endobronchial device.

FIGS. 4A-4G describes the different sequences of the EV or EDD procedure.

FIG. 4A describes insertion of the Endobronchial device using an endoscope.

FIG. 4B describes release of the Endobronchial device in a lung bronchus.

FIG. 4C describes the beginning of a typical EV treatment.

FIG. 4D describes a typical EV treatment in the middle of the treatment cycle.

FIG. 4E describes the lung at the end of an EV treatment cycle.

FIG. 4F describes the EV compensating for collateral flow between lung compartments.

FIG. 4G describes EDD in combination with EV.

FIGS. 5A-5F describe different ventilation cycles of the Endobronchial ventilator device.

FIG. 5A describes an alternating inspiratory-expiratory EV ventilation cycle.

FIG. 5B describes a steady expiratory and steady inspiratory EV ventilation cycle.

FIG. 5C describes an EV cycle that starts with expiratory only and then provides an alternating inspiratory and expiratory EV cycle.

FIG. 5D describes a variably-adjusting EV cycle.

FIG. 5E describes an EV cycle which reduces ventilation amplitudes.

FIG. 5F describes an EV cycle with active expiratory flow and passive inspiratory flow.

FIGS. 6A-6H describe different EV cycles.

FIG. 6A describes an Endobronchial ventilator with a power decay curve greater than the therapy duration.

FIG. 6B describes an Endobronchial ventilator power curve that gradually reduces.

FIG. 6C describes a continuously adjusting EV frequency and amplitude to achieve a desired targeted lung area volume.

FIG. 6D describes an EV cycle with an active expiration on-off cycle and optionally passive inspiration.

FIG. 6E describes an EV cycle with high power in the acute period, medium power in the sub-chronic period and low power in the chronic period.

FIG. 6F describes an EV cycle in which the endobronchial ventilator is removed after the therapy is completed.

FIG. 6G describes an EV cycle in which the cycle is turned on when a physiological threshold is reached.

Fig. GH describes an EV cycle in which the endobronchial ventilator runs out of power, is removed, replaced and EV is then resumed.

FIG. 7A-7K describes different endobronchial ventilator configurations.

FIG. 7A describes a typical isometric view of an endobronchial ventilator.

FIG. 7B describes a sectional view of an endobronchial ventilator.

FIG. 7C describes an endobronchial ventilator with a non-concentric extension.

FIG. 7D describes an endobronchial ventilator with a bifurcated extension.

FIG. 7E describes an endobronchial ventilator with a power supply extension.

FIG. 7F describes an endobronchial ventilator with a modular extension.

FIG. 7G describes an endobronchial ventilator with a flex joint between two main sections.

FIG. 7H describes an endobronchial ventilator with active bi-directional flow.

FIG. 7I describes an endobronchial ventilator with active uni-directional flow and optionally passive flow in the reverse direction.

FIG. 7J describes an endobronchial ventilator with a switch-able flow direction.

FIG. 7K describes an endobronchial ventilator with also drug release capability.

FIG. 7L describes an endobronchial ventilator where the ventilator mechanism can be removed and replaced with a passive plug, or a drug reservoir.

FIG. 8A describes an endobronchial ventilator with an internal battery.

FIG. 8B describes an endobronchial ventilator with a removable battery.

FIG. 8C describes an endobronchial ventilator with an externally attached battery.

FIGS. 9A-9G describe different endobronchial ventilator power generation means.

FIG. 9A describes piezoelectric power.

FIG. 9B describes a sectional view of ultrasonic vibration power.

FIG. 9C describes gyroscopic power.

FIG. 9D describes bioelectric power.

FIG. 9E describes bronchial peristaltic power.

FIG. 9F describes impeller power.

FIG. 10A describes an endoscope system for delivering the endobronchial ventilator.

FIG. 10B describes a sectional view of the endobronchial ventilator in a delivery sheath over the delivery endoscope.

FIG. 11 describes an endobronchial drug delivery device with a drug reservoir.

FIG. 12A describes an endobronchial ventilator or drug delivery device with a non-occlusive anchor.

FIG. 12B describes an endobronchial ventilator or drug delivery device with a non-occlusive anchoring leash.

FIGS. 13A-13F describes EV and EDD being performed on a lung area for the purpose of restoring healthy function to the area.

FIG. 13A describes placement of the endobronchial ventilator and drug pump in a diseased looking lung.

FIG. 13B describes EV of the targeted lung area.

FIG. 13C describes EDD of the targeted lung area.

FIG. 13D describes the drug at the alveoli where it is restoring elasticity and tissue function.

FIG. 13E describes removal of the endobronchial ventilator and drug pump.

FIG. 13F describes a normal lung appearance after the EV and EDD treatment.

FIG. 14 describes EDD being performed on a lung lesion.

FIG. 15A-C describes EDD being performed for systemic drug delivery to treat a disease.

FIG. 15A describes an endobronchial drug pump delivering drug into the lung.

FIG. 15B describes therapeutic drug being absorbed into the blood stream through the alveoli.

FIG. 15C describes the therapeutic drug reaching the intended organs and tissues.

### DETAILED DESCRIPTION OF THE INVENTION

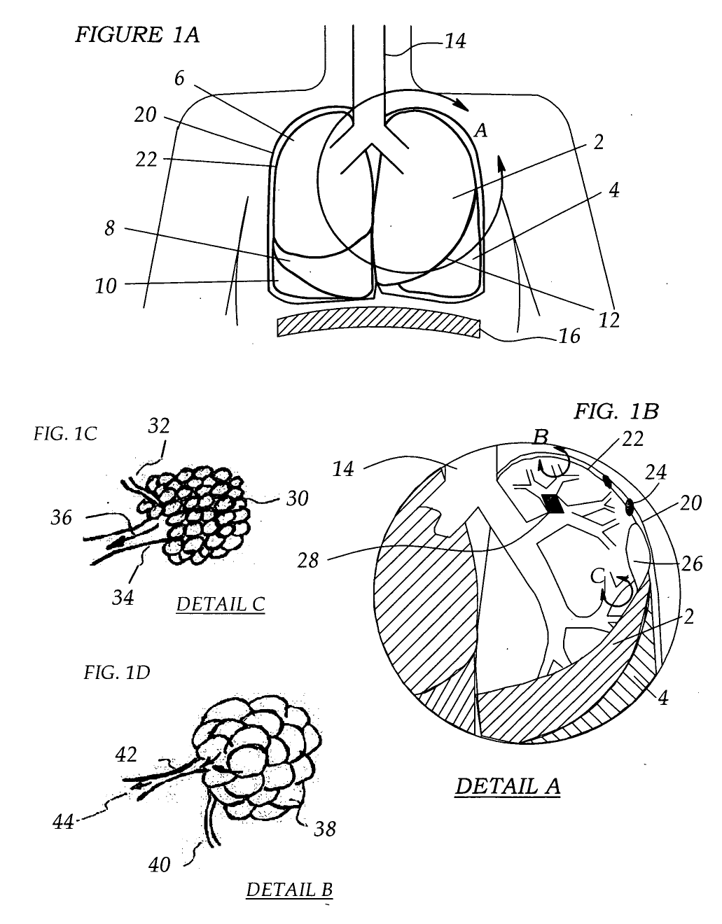

Referring to FIG. 1A the macro anatomy of a lung is shown, showing the left and right lung, trachea 14, the left upper lobe 2, left lower lobe 4, right upper lobe 6, right middle lobe 8 and right lower lobe 10; a lateral fissure 12 separating the lobes, the parietal pleura 20, the visceral pleura 22, and the diaphragm 16. In this example the upper lobes are hyperinflated with emphysema and the lower lobes are compressed by the upper lobes. The diaphragm is distended inferiorly due to the huge residual volume in the lung. Referring to FIG. 1B an EVD 28 is shown in the left upper lung lobe 2. Also shown is a giant bullae 26 which are membranous air vesicles created on the surface of the lung between the visceral pleura 22 and lung parenchyma due to leakage of air out of the damaged distal airways and through the lung parenchyma. The air in the bullae is highly stagnant and does not easily communicate with the conducting airways making it very difficult to collapse bullae. Also shown are pleural tissue adhesions 24 comprised of fibrous tissue between the visceral pleura 22 and the parietal pleura 20 which arise from trauma or tissue fragility. These adhesions render it difficult to promptly deflate an emphysematous hyperinflated lung compartment without inducing tissue injury such as tearing, hemorrhage or pneumothorax.

FIGS. 1C and 1D show a healthy and emphysematous alveoli cluster respectively. The healthy alveoli 30 are small, defined and numerous whereas the emphysematous alveoli 38 are large and hyperinflated with air. The terminal bronchiole 34 is patent in the healthy lung but collapses due to lack of elasticity in the diseased lung 42, the former allowing exhaled flow 36 but the later thwarting exhaled flow 44. Also shown are intersegmental collateral channels, smaller in the healthy lung 32 and larger in the diseased lung 40, which communicate between bronchopulmonary segments making it difficult for a lung compartment to collapse or remain collapsed because of re-supply of air from neighboring compartments through these collateral channels.

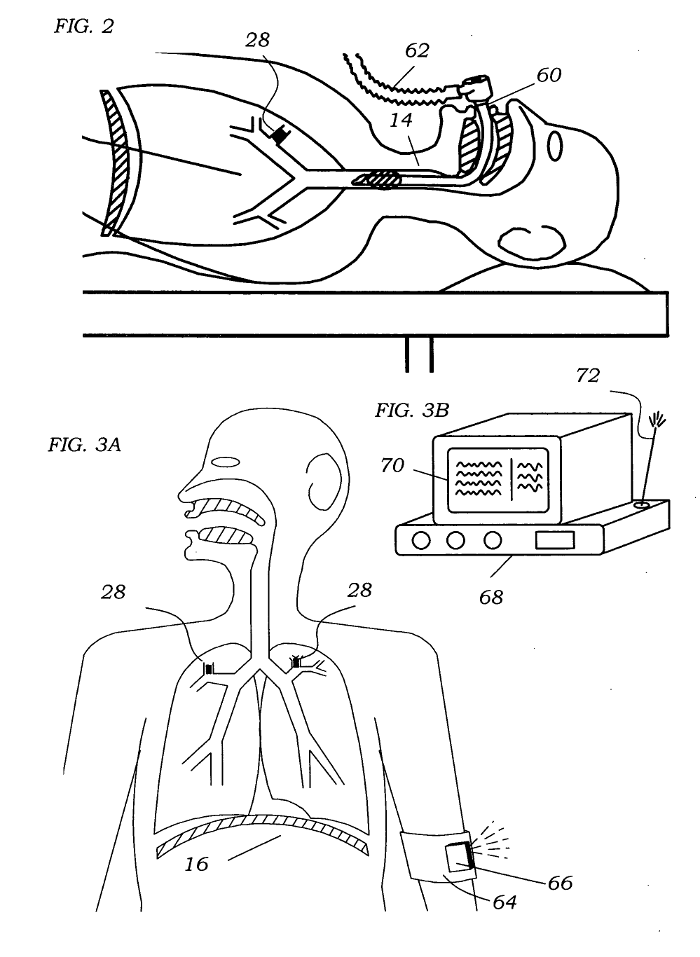

Referring first to FIG. 2, a general layout is depicted of the invention disclosed herein, wherein Endobronchial Ventilation (EV) or Endobronchial Drug Pumping (EDP) is being performed on a ventilatory dependent patient, showing the EVD 28, the trachea 14, an endotracheal tube 60 and a ventilator breathing circuit 62.

Shown in FIG. 3A is a general layout of EV or EDP being performed on an ambulatory spontaneously breathing patient with emphysema. Two upper lobe segment EVD's are shown 28 as well as a curved diaphragm muscle illustrating that the EV has effectively reduced the hyperinflation. Shown in FIGS. 3A and 3B is an optional transmitter 66 worn on a band 64 and a receiver 72 such that the EV procedure can be monitored 70 and controlled by a station 68.

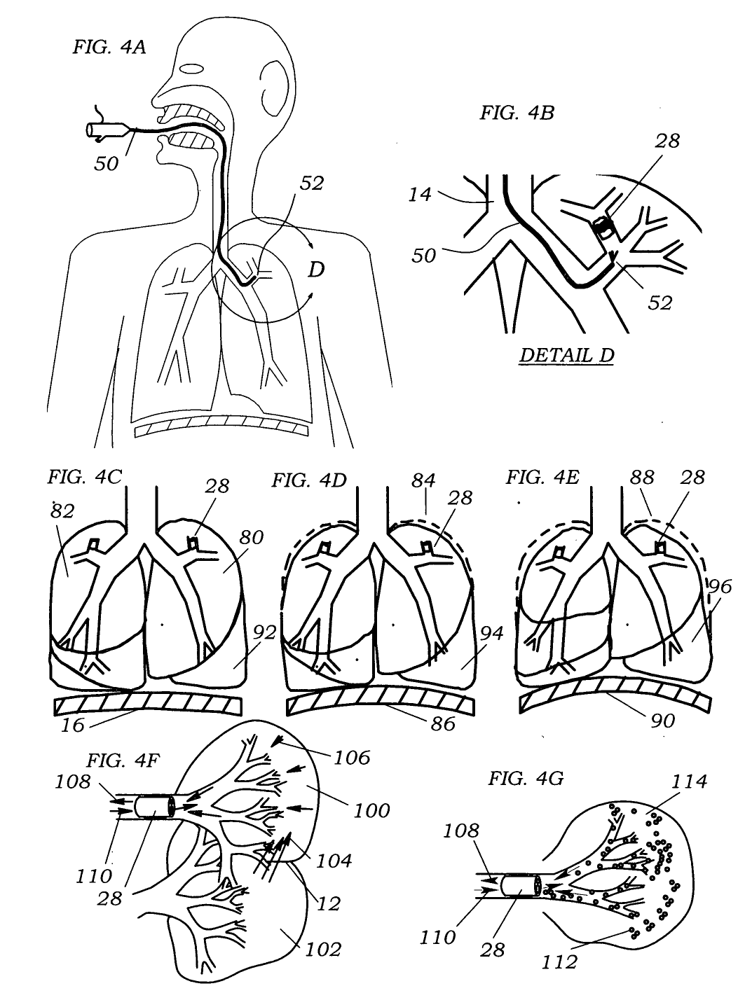

FIGS. 4A-4G describes the different sequences of the EV procedure. First, the EVD is delivered to the targeted bronchus by advancing the tip 52 of a bronchoscope 50 to the area. The EVD 28 is then delivered. Initially, FIG. 4C, the upper lobes are hyperinflated 80 and 82 and the lower lobes are compressed 92 and the diaphragm is distended 16. Then, FIG. 4D, the upper lobes begin to reduce in size 84 allowing the lower lobes to receive more inspired air 94 and allow the diaphragm to relax 86. Finally, FIG. 4E, the upper lobes are reduced 88 in volume to the desired volume and the lower lobes receive even more air 96 to contribute to tidal volume breathing and the diaphragm is properly leveraged 90 in the chest.

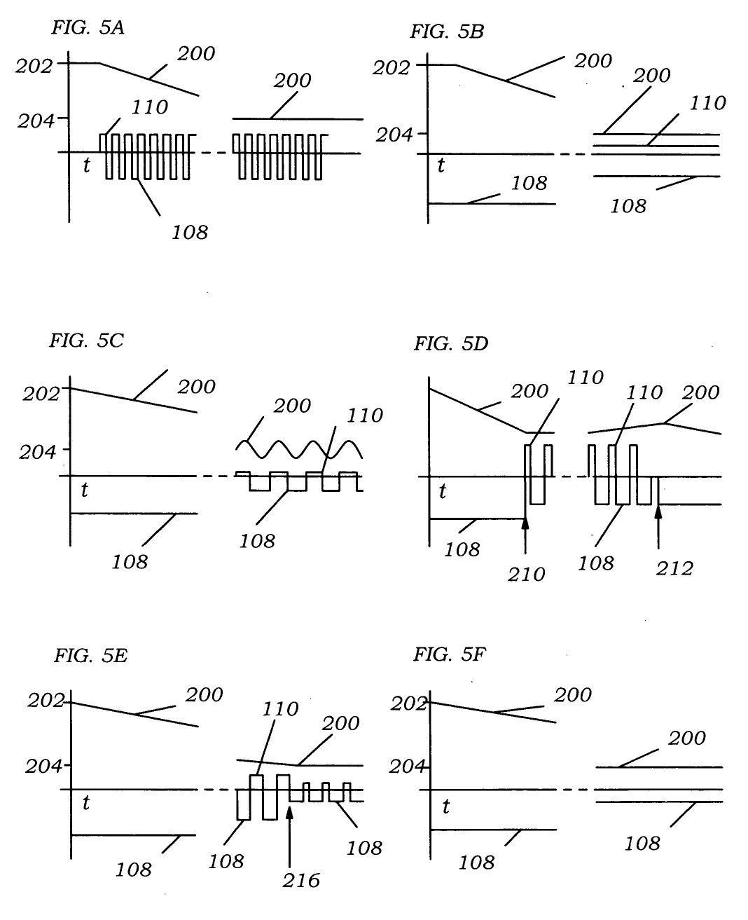

FIG. 5A-F describes typical duty cycles of EV. 202 depicts the hyperinflated volume of the targeted area and 204 depicts the therapeutic volume achieved by EV. 110 depicts air flow delivered into the targeted area via the EVD during the inspiratory phase and 108 depicts the air flow removed from the targeted area during the expiratory phase via the EVD. Air removal is active by a transport mechanism within the EVD; Air delivery is either active by a transport mechanism in the EVD or passive through or around the EVD. The mantissa is the time ordinate, t, and the abscissa indicates the treatment amplitude. In FIG. 5A the targeted lung area volume 200 is reduced from a hyperinflated level 202 to a therapeutic healthy level 204 by the EVD which applies an alternating gas removal 108 and delivery 110 to the area. Eventually volumetric equilibrium is reached in the lung area; EVD ventilation, oxygen and CO₂ diffusion, and collateral channel airflow reach a steady state. EV air removal 108 is typically greater in amplitude than air delivery 110 to compensate for airflow into the targeted area from neighboring lung areas through collateral channels.

FIG. 5B describes an EV cycle with a first stage of constant gas removal 108, and a second stage of reduced gas removal and the appropriate amount of gas delivery 110. The EV parameters are regulated to maintain the desired therapeutic volume in balance with other gas influx and efflux. FIG. 5C describes an EV mode in which the volume is reduced by constant air removal followed by alternating gas removal and delivery to sustain the therapeutic volume 204, in which case EV can be synchronized with the patient's normal breath cycle or can range from high to low frequencies such as 1 cycle per second to 1 cycle per hour. FIG. 5D describes an EV mode with volume thresholds which switch EV to an alternating gas delivery-removal cycle 210 or back to a gas removal only cycle 212. FIG. 5E describes EV with first an acute phase of gas removal only, a second sub-chronic phase of alternating gas removal and delivery until therapeutic volume is reached 216, then a third chronic phase with reduced gas removal and delivery amplitudes to maintain the therapeutic level. FIG. 5F describes EV in which only active gas removal 108 is applied by the EVD to reach therapeutic volume 204 after which gas removal rates are reduced to sustain the desired level.

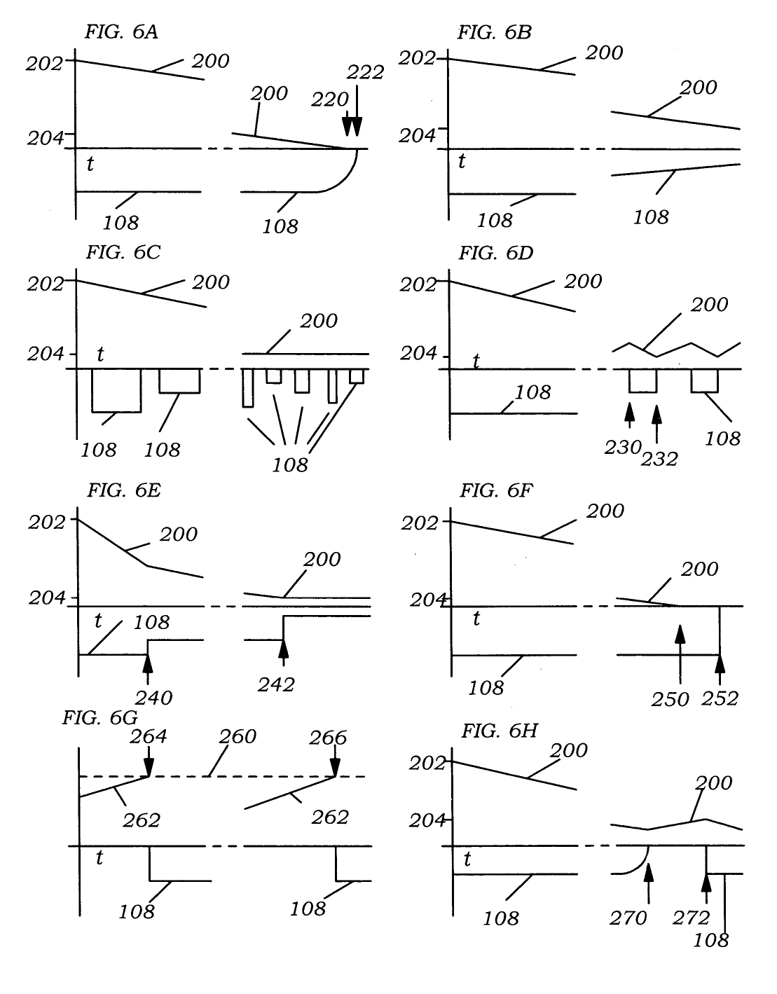

FIGS. 6A-6H describe different EVD duty cycles used for different EV profiles, t indicating time and the abscissa indicating treatment amplitude. Gas removal 108 is used to reduce the lung area volume 200 from a hyperinflated level 202 to a therapeutic level 204. Gas delivery not depicted in these figures can be either active, passive or absent. FIG. 6A describes an EVD power decay at a duration 222 greater than the expected therapeutic period 220. FIG. 6B describes an EVD power curve 108 which dissipates with time thus reducing the rate of gas removal. FIG. 6C describes an EVD on-off cycle of variable amplitudes and durations, adjusted as necessary to regulate the desired resultant effect, thus causing variable levels of gas removal 108. FIG. 6D describes an EVD duty cycle which is at first constant then is off until the volume reaches a high threshold 230 which automatically switches the EVD on. The EVD automatically turns off when the volume reduces to a low threshold 232. FIG. 6E describes an EVD duty cycle starting with a high power acute stage to reduce a substantial amount of volume relatively quickly, for example 0.5 liters in 3 days, then switching 240 to medium power to reduce another substantial amount of volume but over a safe period of time to prevent tissue shearing and allow for tissue remodeling, for example another 0.5 liters over 21 days, then converting to a low power maintenance mode 242 to maintain the volume at the therapeutic level 204. FIG. 6F describes an EVD duty cycle in which the EVD is removed, the power is turned off or the active mechanism is replaced with a passive plug at a time 252 after the therapeutic effect is reached 250. FIG. 6G describes an EVD duty cycle in which a physiological parameter 262 is measured which when reaching a certain threshold 260 the EVD turns on and gas removal commences 264, 266. FIG. 6H describes an EVD duty cycle in which the EVD power dissipates 270 and then resumes 272 by recharging, replacement or the like. It can be appreciated that the embodiments described in FIGS. 6A-6H can be applied also to duty cycles of an EDP during EDD in which case fluid flow 108 is instead drug release. Further it can be appreciated that the embodiments described in FIGS. 5A-5F and 6A-6H can pertain to EV in conjunction with EDD.

Referring back to FIGS. 4F and 4G, FIG. 4F describes collateral flow of air 104 crossing from a neighboring area 102 into the treatment area 100 despite a fissure 12. Collateral flow air is aspirated 106 out of the treatment area by the EVD 28. FIG. 4G describes an EVD ventilating the targeted area 114 with fluid removal 108 and delivery 110, while also delivering a therapeutic 112.

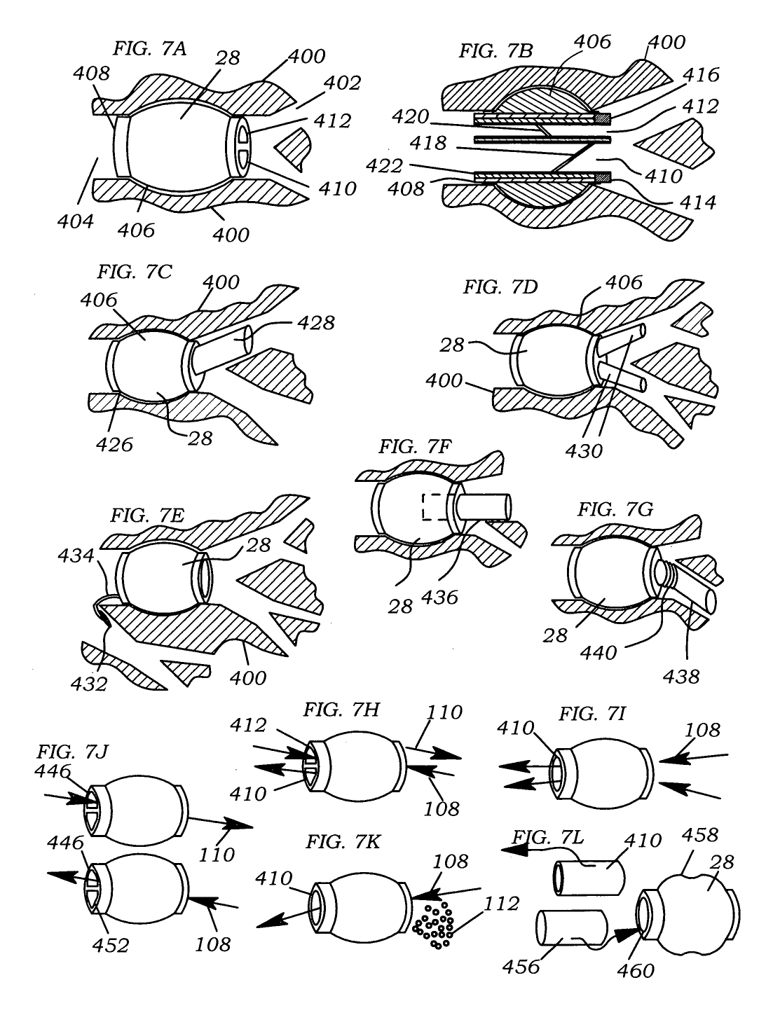

Now referring to FIGS. 7A-7L alternative EVD configurations are shown. FIG. 7A describes an EVD 28 in a bronchial tube 400 with a proximal end 404 and a distal end 402. The EVD is comprised of a housing 408, a sealing feature 406 in this case a compliant cuff to seal it to the bronchial wall 400, a ventilation gas delivery mechanism 412 and a ventilation gas removal mechanism 410. A cross-sectional view, FIG. 7B, indicates the bronchial wall 400; the sealing cuff 406; the EVD housing 408; the fluid removal mechanism 410 with an element to propel fluid 418; the gas delivery mechanism 412 with a propulsion element 420; a power storage means 422 in this case a thin film wrapped battery coupled to a power transmission means for example a coil, not shown; a microchip 414 for controlling or monitoring, optionally including a physiological sensor, not shown; and a drug reservoir 416. FIG. 7C describes an EVD with an offset extension 428 to facilitate fitting in a bifurcated area. FIG. 7D describes an EVD with two distal extensions 430 also for bifurcated placements. FIG. 7E describes an EVD with an element 432 extending from the proximal side by a leash 434. This configuration allows the EVD to be clipped onto a bifurcation septum. The element 432 can include a battery, physiological sensor, drug reservoir or other functional elements of the EVD. FIG. 7F describes an EVD with a removable extension 436 which can include the fluid transport mechanism, battery, drug reservoir or other components. FIG. 7G describes an EVD with a flexible midsection 440 to facilitate placement in non-straight airways such that the distal portion 438 can bend. FIG. 7H describes an EVD in which fluid removal 108 and delivery 110 occur in independent channels 410 and 412 respectively. FIG. 7I describes an EVD with fluid removal 108 only through the appropriate transport mechanism 410. FIG. 7J describes an EVD which switches direction of fluid transport from delivery 110 to removal 108 through the same mechanism or channel 446. Also shown is an optional access port 452 in order to access the area distal to the EVD with an instrument or catheter, for example to deliver medicine, measure a physiological parameter or remove mucus. FIG. 7K describes an EVD with both a ventilation function of aspirating fluid 108 through a transport mechanism 410 and also a drug 112 delivery capability. FIG. 7L describes an EVD in which the active fluid transport mechanism 410 is electively removable from the EVD lumen 460 and replaced with a passive plug 456 to seal the airway to airflow. Alternatively the item 456 can be a drug reservoir. An hour-glass-shaped cuff 458 is also shown to help seal and retain the EVD to the bronchial wall or at a bifurcation. The EVD fluid transport mechanism can be of a variety of types: a Diaphragm Pump, Peristaltic Pump, Roller Pump, Rotary Vane Pump, Piston Pump, Alternating Piston Pump, Rotary Piston Pump, Lobe Pump, Impeller Pump, Screw Pump, Syringe Pump, Axial Flow Propeller Pump, Bladder Pump, Magnetic Drive Pump, Electromagnetic Pump, MEMS Pump, Osmotic Pump, Piezoelectric Pump, Electrohydrodynamic Pump, Reciprocating Pump, Membrane Pump, Oscillatory Pump or Ultrasonic Pump, among other mechanism types.

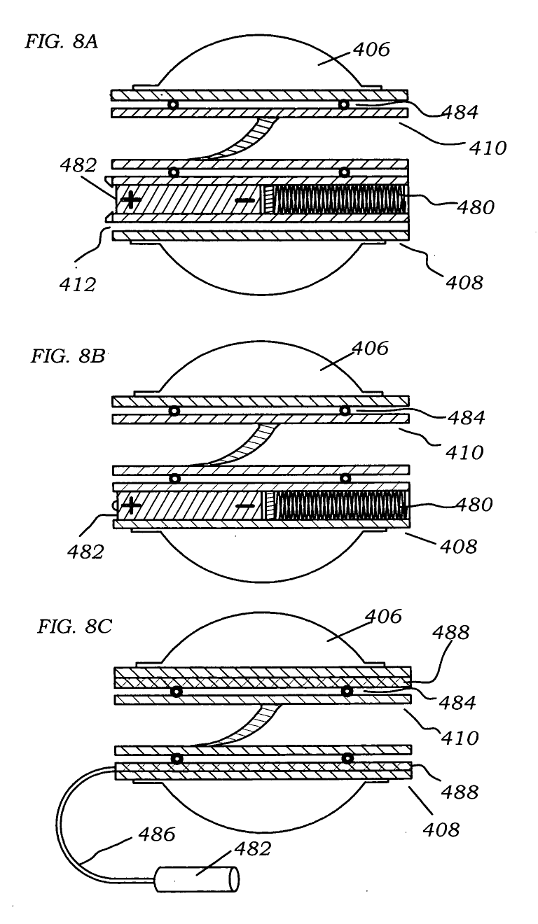

FIGS. 8A-8C describe additional alternative details of the EVD. FIG. 8A describes a battery 482 which is contained in the EVD; a gas removal mechanism 410 which propels fluid by rotating within a housing with o-ring seals 484 enabling free rotation; a passive fluid flow port 412 for air delivery into the distal area or for mucus removal or drug delivery; a power transmission means 480. FIG. 8B describes a battery 482 which is electively removable from the EVD. FIG. 8C describes a battery 482 which is externally attached to the EVD with a cord 486 and located in a neighboring airway. FIG. 8C also describes a concentric electrical coil 488 which by virtue of Gauss's law spins the mechanism 410 to propel fluid. It can be appreciated that EVD batteries can be replaced or can be recharged by inductance charging from outside the body or direct endobronchial charging in-vivo using a catheter.

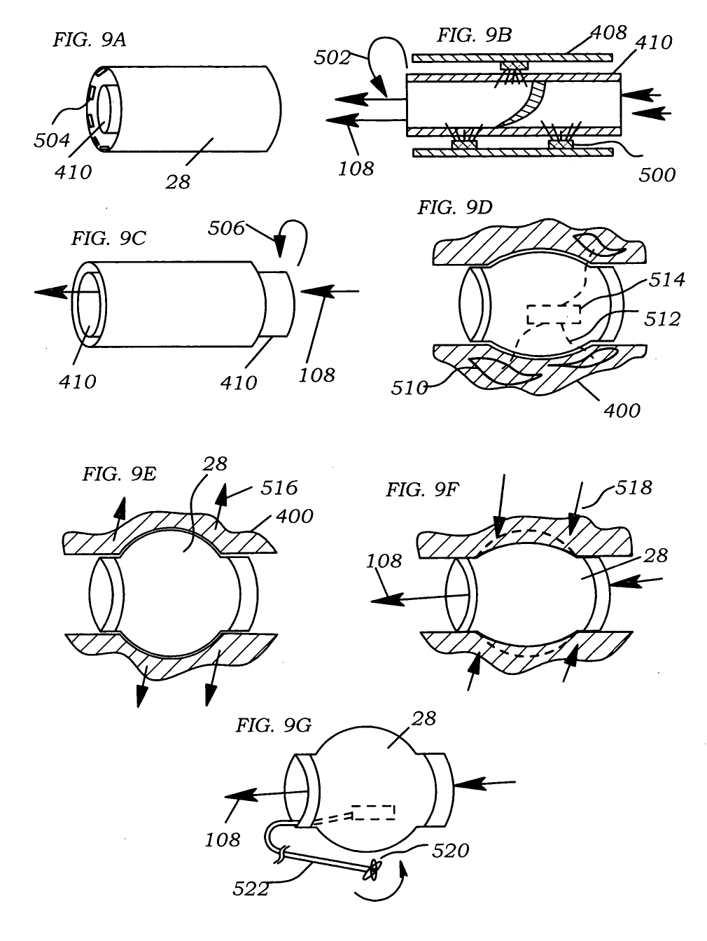

FIGS. 9A-9G describe optional ventilation or fluid propulsion mechanisms. FIG. 9A describes piezoelectric elements 504 used to activate a propulsion mechanism 410. FIG. 9B describes ultrasonic emitters 500 that create rotationally powered 502 propulsion 108 via vibrational power. FIG. 9C describes gyroscopic power using an offset propulsion mechanism 410 that rotates 506 in response to body motion. FIG. 9D describes bioelectric power harnessed from muscles 510 using leads 512 connected to a storage cell 514. FIGS. 9E and 9F describe propulsion 108 created by harnessing power from bronchial contraction 518 and dilation 516. FIG. 9G describes power generated by an impeller 520 spun by airflow in a lung airway and transmitted to the EVD via a cable 522.

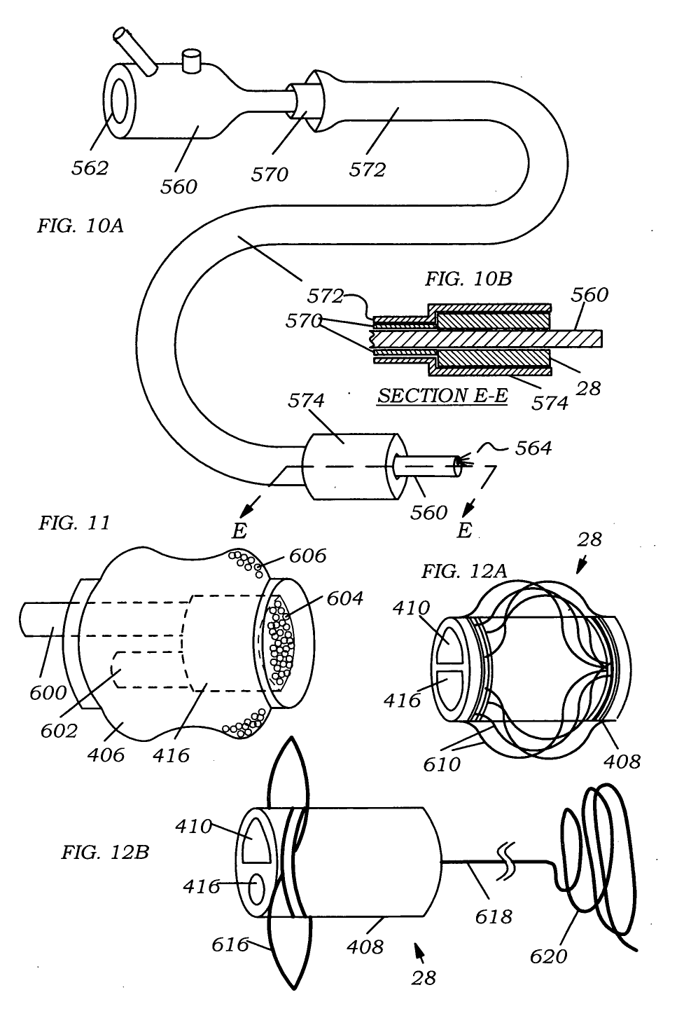

FIG. 10A describes a delivery system for the EVD or EDP, indicating a delivery bronchoscope 560 with viewing lens 562 and objective lens 564; A sheath 572 with an enlarged distal end section 574 housing the EDP or EVD. FIG. 10B describes a sectional view of the EVD or EDP 28 during delivery indicating the bronchoscope 560, sheath 572 with enlarged section 574, and an inner sleeve 570 used to push the EDP or EVD out of the sheath 574.

FIG. 11 describes an EDP with a sealing anchoring cuff 406, a drug cartridge 600 optionally removable, a power or control module 602, and a drug reservoir 416 with drug release ports 604. Optionally drug can be stored in and released from the cuff 406 through ports 606.

FIG. 12A describes an EVD or EDP with a non-occlusive anchoring member 610 attached to the housing 408 and FIG. 12B describes an EVD or EDP with a non-occlusive anchor 620 leashed 618 to the device 28 and an anchor 616 attached to the main housing 408, each with optional drug reservoirs 416. Such configurations allow for EV or EDD without occluding the host airway.

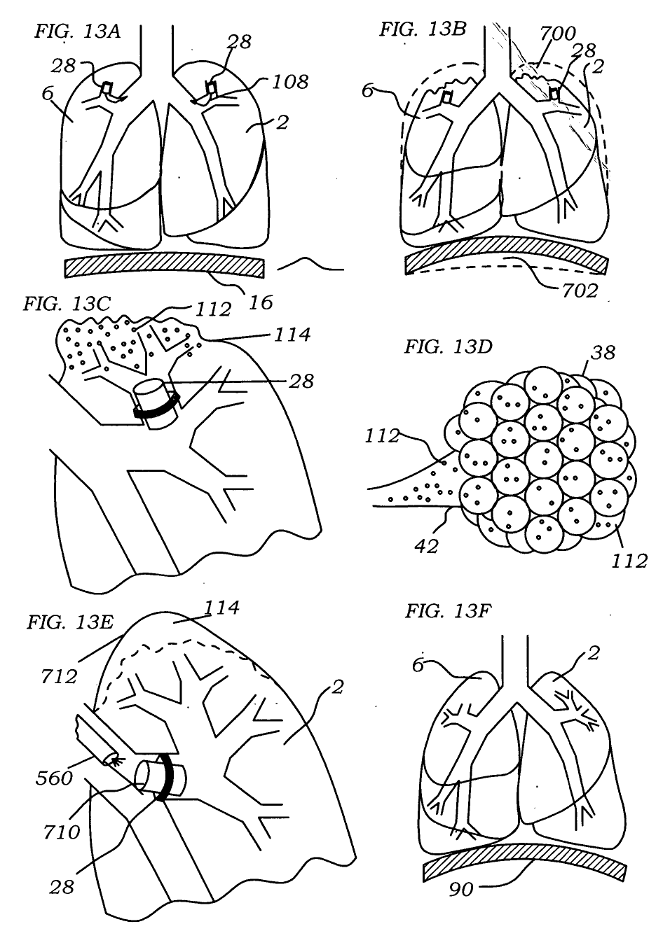

FIGS. 13A-13F describe a cure for a lung disease such as emphysema wherein the EVD/EDP device 28 is implanted in the right upper 6 and left upper 2 lobes and initially evacuate fluid 108 from the upper lobes. As the procedure continues, FIG. 13B, the upper lobes reduce in size 700 and the diaphragm 16 starts to return to normal and the lower lobes participate more in ventilation. Once the upper lobes are substantially reduced thus relieving the patient's suffering, a therapeutic agent 112 is delivered to the targeted area 114, FIG. 13C. The agent 112 enters the alveoli 38 through the terminal bronchioles 42 where the agent restores the elasticity and tissue structure of the impaired alveoli, FIG. 13D. After sufficient therapy, the EVP/EDP device 28 is removed, FIG. 13E, by using the bronchoscope 560 and a grasping tool 710. The upper lobes 2 return to a more normal volume 712 and the diaphragm returns to normal 90, FIG. 13F. In this scenario the agent can be for example stem cells, a genetically derived agent, or other biologics that can regenerate or protect the elasticity and restore the structure of the broken down tissue.

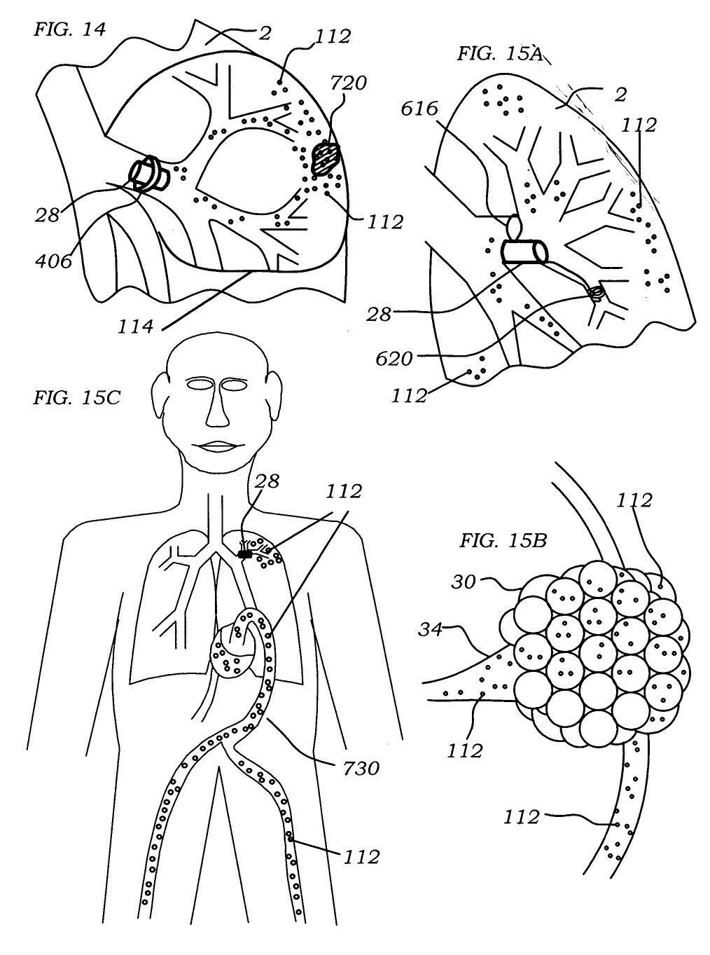

FIG. 14 describes an EDD procedure to treat a lesion 720 in a lung area 114 by delivering an agent 112 via the EDP 28 while sealing the area 114 from the rest of the lung with a sealing cuff 406. This treatment can deliver a caustic agent to a lesion without inadvertent spreading of the agent to healthy areas. FIG. 15A describes an EDD procedure where an agent 112 is released by an EDP 28 which is placed non-occlusively in a lung airway by using non-occlusive anchors 616 and 620. The agent travels to the alveoli 30 via the terminal bronchioles 34 where it diffuses into the arterial blood stream, FIG. 15B, then to the heart and to the targeted organ or tissue via the circulatory system 730, FIG. 15C. It can be appreciated that a variety of organs, tissues or areas can be targeted with disease-specific agents, or EDD can be used to deliver agents to treat diffuse lung diseases such as COPD, asthma, bronchitis, cystic fibrosis, and that the agent release can be continuous or regulated by monitoring a physiological parameter, or controlled externally using telemetry or the like.

TABLE 1
Additional Specifications: *

| 1. | Dimensions: | |
|---|---|---|
| | 1.1. | Subsegment bronchus implant: 2-5 mm OD × 5-10 mm length |
| | 1.2. | Segment bronchus implant: 5-12 mm OD × 5-15 mm length |
| | 1.3. | Lobar bronchus implant: 8-18 mm OD × 10-20 mm length |
| | 1.4. | Mainstem bronchus implant: 12-20 mm OD × 10-22 mm length |
| 2. | Bronchial dilitation: 67%-150% dilation. | |
| 3. | Materials: | |
| | 3.1. | Housing: Silicone, urethane, Teflon, Ultem, TPE, PTFE, elastomer coated foam. |
| | 3.2. | Ventilation Mechanism mechanism: Titanium, 400 series SS, gold plated metal, |
| | | titanium nitrate coated aluminum or steel, Delrin, Ultem, liquid crystal polymer, |
| | | ceramic. |
| | 3.3. | Outer seal: Shape-memory polyurethane foam, 1-2 lbs/ft 3 density self-expanding |
| | | compressible design. Elastomer covering: 0.001″-0.002″ thick silicone or urethane |
| | | or PFTE with 500% elongation. |

| | |
|---|---|
| 4. | Power Storage: Lithium iodide or lithium vanadium pentoxide battery |
| 5. | Flexible radius of curvature: 7/16″-11/16″ |
| 6. | Ventilation Mechanism stroke volume: 0.05 ml-1.0 ml |
| 7. | Ventilation Mechanism pressure head: 0.25 cmH2O-10 cmH2O |
| 8. | Ventilation Mechanism viscosity range: Gases w/ densities/viscosities similar to air & |
| | substances w/ viscosities similar to mucous (˜5000 cp) |
| 9. | Back pressure leak resistance: 20-50 cmH2O |
| 10. | Ventilation Mechanism power consumption: .01-1.0 watts/hr |
| 11. | Ventilation Mechanism drive voltage: 0.10-1.0 VDC |
| 12. | Current draw: .001-.010 amps |
| 13. | Stroke type: unidirectional, positive displacement |
| 14. | Minute volume: 0.08-.0001 Liters/hr |
| 15. | Packaging: Packaged in double sterile package, w/ battery disconnected |
| 16. | Reservoir volume (if outfitted): 0.05-1.0 ml |

* Exemplary specifications only. Parameters, values and embodiments may vary.

1. A method for ventilating a lung area by implanting an active ventilation mechanism into an airway feeding said lung area, wherein said mechanism transfers fluid from the distal side of said mechanism to the proximal side, and wherein mechanism transfers inspired air from the proximal side of said mechanism to the distal side, and further wherein the fluid transfer rates are regulated to achieve a desired ventilation volume of the targeted lung area.

2. A method for treating a lung area with a therapeutic agent by implanting a drug release mechanism into a feeding bronchus of said lung area.

3. A method for delivering a therapeutic agent to lesion, an organ, an area or a tissue in the body by implanting a drug release mechanism in the lung bronchial tree and wherein said mechanism releases said agent into the lung airways, and further wherein said drug absorbs into the blood stream through the gas transfer surface.

4. A method for ventilating a lung area and treating a lung area with a therapeutic agent by implanting an active ventilation mechanism into an airway feeding said lung area, wherein said mechanism transfers fluid from the distal side of said mechanism to the proximal side, and wherein mechanism transfers inspired air from the proximal side of said mechanism to the distal side, and further wherein the fluid transfer rates are regulated to achieve a desired ventilation volume of the targeted lung area, wherein the mechanism future releases said therapeutic agent.

5. A method as in claim 1 wherein said apparatus substantially occludes said airway except for throughput of said apparatus.

6. A method as in claim 1 wherein said power of said apparatus can be disabled.

7. A method as in claim 1 wherein said apparatus is implanted permanently.

8. A method as in claim 1 wherein said apparatus is implanted temporarily (acutely, sub-chronically, or chronically).

9. A method as in claim 1 wherein said apparatus transports said fluid or substance continuously.

10. A method as in claim 1 wherein said apparatus transports said fluid or substance intermittently.

11. A method as in claim 1 wherein said apparatus transports said fluid or substance indefinitely.

12. A method as in claim 1 wherein said apparatus transports said fluid or substance for a fixed duration.

13. A method as in claim 1 wherein said apparatus transports said fluid or substance as required physiologically (such as determined by moisture, pressure, pH, ultrasound).

14. A method as in claim 1 wherein said apparatus transports said fluid or substance upon demand from a person.

15. A method as in claim 1 wherein said apparatus transports said fluid or substance at a rate and cycle that decays over time.

16. A method as in claim 1 wherein said apparatus transports said fluid or substance in synchrony with the breathing cycle.

17. A method as in claim 1 wherein said apparatus comprises a plurality of different pump parameter settings, and wherein said apparatus transports said fluid or said substance at said different settings, wherein said apparatus switches from one set of said parameters to a next set of said parameters, and wherein said switching is time-based or physiologically based or user controlled.

18. A method as in claim 1 wherein said apparatus transports said fluid or substance wherein said pumping parameters create said substantial volume reduction gradually, wherein gradual reduction is between 12 hours and 90 days, most typically between 3 and 30 days.

19. A method as in claim 1 wherein said apparatus transports said fluid or substance using a set of pumping parameters to achieve substantial volume reduction of said area, and wherein said apparatus after substantial reduction is achieved switches to a different set of ventilation parameters to maintain volume reduction.

20. A method as in claim 1 wherein said apparatus transports said fluid at a pattern determined by information received by a sensor.

21. An apparatus for ventilating a lung area comprising a gas removal and gas delivery mechanism wherein said apparatus is sized for implantation in a airway of said lung area.

22. An apparatus for delivering a therapeutic agent to a lung area or to an organ or tissue in the body, said apparatus comprising a drug storage means, a drug release means and an anchoring means to anchor said apparatus in a bronchial tube of the lung.

23. An apparatus for delivering a therapeutic agent to a lung area and for ventilating a lung area, wherein said apparatus is implantable in a bronchus feeding said lung area, wherein said apparatus comprises an active ventilation mechanism and wherein said apparatus further comprises a reservoir of said agent and a release system to release said agent.

24. An apparatus as in claim 21 wherein said apparatus comprises an internal power source.

25. An apparatus as in claim 21 wherein said apparatus is connected to a power source implanted in the lung airways.

26. An apparatus as in claim 21 wherein said apparatus is connected to an implanted power source implanted outside the lung airways.

27. An apparatus as in claim 21 wherein said apparatus is connected to an external power source external to the body.

28. An apparatus as in claim 21 wherein said apparatus is powered by a replaceable power source.

29. An apparatus as in claim 21 wherein said apparatus is powered by a rechargeable power source.

30. An apparatus as in claim 21 wherein said apparatus is powered by physiologically generated power (such as thermally, electrophysiologically, biologically, through motion, etc.).

31. An apparatus as in claim 21 wherein said apparatus comprises a plurality of different pump parameter settings, and wherein said apparatus pumps said fluid or said substance at said different settings, wherein said apparatus switches from one set of said parameters to a next set of said parameters, and wherein said switching is time-based or physiologically based or user controlled.

32. An apparatus as in claim 21 wherein said apparatus further comprises a microchip wherein operational parameters are stored on said microchip.

33. An apparatus as in claim 21 wherein said apparatus comprises an instrument pass-through port and wherein an instrument can be passed through said port to sample, monitor, or treat said area distal to said apparatus.

34. An apparatus as in claim 21 wherein said ventilation mechanism comprises an active flow delivery means to said lung area and an active flow removal means from said lung area.

35. An apparatus as in claim 21 wherein said ventilation mechanism comprises a single mechanism for active flow delivery and active flow removal, wherein said delivery and said removal alternate.

36. A method as in claim 2 wherein said therapeutic substance is released in the lung to treat a lung disease, such as asthma, bronchitis, cancer, cystic fibrosis, emphysema, SARS, pneumonia, post-obstructive pneumonia or the like.

37. A method as in claim 3 wherein said therapeutic substance is released in the lung to diffuse into the tissue, bloodstream or lymphatic system to treat a non-lung disease, such as heart disease, vascular disease, skeletal-muscular diseases, systemic diseases, neurological diseases, endocrine diseases, pain, diabetes, hypertension, or the like.

38. An apparatus as in claim 21 wherein said ventilation comprises displacement volumes in the range of 0.05 ml-1.0 ml/stroke

39. An apparatus as in claim 21 wherein said ventilation comprises displacement flow rates in the range of or 0.08-0.0001 Liters/hr

40. An apparatus as in the claim 22 wherein said apparatus comprises an active pump mechanism.

41. An apparatus as in the claim 23 wherein said apparatus comprises an active pump mechanism.

42. An apparatus as in the claim 22 wherein said apparatus does not occlude said airway.

43. An apparatus as in the claim 23 wherein said apparatus does not occlude said airway.

44. An apparatus as in claim 22 comprising a size typically designed for implantation in the segmental bronchus, 8-12 mm OD×5-20 mm length, most typically two sizes, 9 mm OD and 12 mm OD by 20 mm overall length, and further wherein other sizes are available for implantation into other sites.

45. An apparatus for pumping therapeutic substances as in claim 22 comprising a reservoir with said substance typically in the range of 0.1-0.5 ml.

46. An apparatus for pumping therapeutic substances as in claim 22 wherein the release rate of said substance is in the range of 1×10⁻⁴ to 1×10⁻³ ml/hr.

47. An apparatus for pumping therapeutic substances as in the above claim 22 further comprising a refillable substance reservoir.
